(19) United States
(12) Patent Application Publication
(10) Pub. No.: US 2010/0188518 A1
(43) Pub. Date: Jul. 29, 2010

(54) IMAGING APPARATUS AND METHOD OF DRIVING IMAGING APPARATUS

(75) Inventor: Masafumi Inuiya, Kanagawa (JP)

Correspondence Address: Studebaker & Brackett PC, One Fountain Square, 11911 Freedom Drive, Suite 750, Reston, VA, 20190, US

(73) Assignee: FUJIFILIM CORPORATION, Tokyo (JP)

(21) Appl. No.: 12/692,931

(22) Filed: Jan. 25, 2010

(30) Foreign Application Priority Data
Jan. 26, 2009 (JP) 2009-014229

(51) Int. Cl. H04N 5/225

(52) U.S. Cl. 348/220.1; 348/E05.024; 348/E05.091; 348/308; 348/273

(57) ABSTRACT

An imaging apparatus includes plural pixel portions each having a photoelectric conversion portion and an electric charge accumulating portion that accumulates electric charges. Imaging signals corresponding to amounts of the electric charges in the electric charge accumulating portions are read out. The imaging signals of two adjacent lines of pixel portions are added. In still-image shooting, a first operation and a second operation are performed every exposure operation. The first operation reads out the imaging signals using a pattern containing combinations of two adjacent lines, adds the imaging signals of the two adjacent lines and outputs the added image signals as a field signal. The second operation reads out the imaging signals using a pattern being obtained by shifting the pattern for the first operation by one line, adds the imaging signals of the two adjacent lines and outputs the added image signals as another field signal.

### CROSS-REFERENCE TO RELATED APPLICATIONS

This application claims the benefit of Japanese Patent Application No. 2009-14229, filed Jan. 26, 2009, the entire contents of which are hereby incorporated by reference, the same as if set forth at length.

### BACKGROUND OF THE INVENTION

1. Technical Field

The invention relates to an imaging apparatus and a method of driving an imaging apparatus.

2. Description of the Related Art

At present, imaging apparatuses such as a digital camera and a digital video camera which generate image signals by shooting subjects using an image sensor such as a CCD or a CMOS as an imaging device are widely used.

When a still image is shot by such an imaging apparatus, in order to shoot a specific moment of a subject, a shutter that is simultaneously opened for all the pixels at a time when exposure starts and closed for all the pixels at a time when the exposure ends are required. On the other hand, when a moving image is shot, it is necessary to record/display a shot image in a standard TV format (for example, 60 fields, 30 frames, and 2:1 interlace). Accordingly, by operating a shutter in units of fields, the motion of a subject included in a moving image becomes smooth without being a stroboscopic action.

As a shutter, there are (i) a mechanical shutter that performs exposure control for all the pixels by physically driving a light-shielding member to be opened or closed and (ii) an electronic shutter that controls generation of signals in each pixel by an electronic control method. Examples of the electronic shutter include a rolling shutter system and a global shutter system.

The rolling shutter system is a driving system in which signals are read out by setting different exposure periods for respective rows of the arranged pixels. On the other hand, the global shutter system is a driving system in which signals of each row are read out by performing exposure for a same period for each row of the arranged pixels. Generally, in moving-image shooting, the rolling shutter system is employed for prioritizing high speed for signal read-out. On the other hand, in still-image shooting, the global shutter system is employed for prioritizing simultaneousness of exposure and high image quality.

As a method for reading out signals that is suitable for moving-image shooting, for example, there is a line sequential color difference method. In the line sequential color difference method, complementary color filters are disposed above the arranged pixels, signals of pixels of odd lines out of the pixel lines are set as read-out signals of a field A, signals of pixels of even lines are set as read-out signals of a field B, and two field signals of the fields A and B are read out for one frame. On the other hand, in still-image shooting, such a method is frequently employed that color filters, in which RGB are arranged in the Bayer format, are disposed above pixels, and signals of all the pixels are read out by sequentially reading out the signal of one line each time.

JP 2002-280537 A (corresponding to U.S. Pat. No. 6,781,178) relates to an imaging device having a non-volatile memory structure which will be described later.

JP Hei. 7-298140 A describes an imaging apparatus mainly for moving-image shooting. In still-image shooting, an imaging device is light-shielded by a mechanical shutter, an image based on an A-field signal and an image based on a B-field signal are sequentially read out and are temporarily stored in a memory without pixel mixture, one odd line and one even line are simultaneously read out from the memory, and a still image is generated.

JP Hei. 5-219441 A selectively scans while two adjacent lines of arranged pixels are sequentially shifted by one line, thereby acquiring signals whose amount is equal to that in the two-row mixed interlaced scanning.

JP 2002-280537 A has newly proposed an imaging device in which a signal voltage corresponding to electric charges generated in a photoelectric conversion portion can be held in a non-volatile memory. In this imaging device, even when the signal voltage is read out from the non-volatile memory, the electric charges of each pixel are maintained in a non-destructive state. By utilizing such a feature, a new exposure and a new read-out operation have been studied.

Also, recently, in a video camera that is mainly used for moving-image shooting, a still-image shooting function tends to be provided. On the other hand, in a digital still camera that is mainly used for still-image shooting, a moving-image shooting function tends to be provided. Accordingly, from the viewpoint of a signal format for exposure, signal read-out, and imaging, an imaging apparatus that is appropriate for both of moving-image shooting and still-image shooting has been demanded. However, at present, such an imaging apparatus has not been proposed.

### SUMMARY OF THE INVENTION

The invention has been made in view of the above circumstances and provides an imaging apparatus and a method of driving an imaging apparatus that are appropriate for both moving-image shooting and still-image shooting.

According to an aspect of the invention, an imaging apparatus includes a plurality of pixel portions that are arranged in a matrix manner, a read-out circuit, a pixel adder and a controller. Each pixel portion includes a photoelectric conversion portion and an electric charge accumulating portion. Each electric charge accumulating portion is disposed above a semiconductor substrate and accumulates electric charges generated in the corresponding photoelectric conversion portion. The read-out circuit reads out imaging signals corresponding to amounts of the electric charges accumulated in the electric charge accumulating portions. The pixel adder adds the imaging signals of two adjacent lines of pixel portions among the plurality of pixel portions. In still-image shooting, the controller performs a first operation and a second operation every exposure operation in which electric charges in the photoelectric conversion portions are discharged and then electric charges are accumulated in the photoelectric conversion portions, so as to output signals of one frame. The first operation reads out the imaging signals using a pattern containing combinations of two adjacent lines, adds the imaging signals of each combination of the two adjacent lines and outputs the added image signals as a field signal. The second operation reads out the imaging signals using a pattern containing combinations of two adjacent lines and being obtained by shifting the pattern for the first operation by one line, adds the imaging signals of each combination of the two adjacent lines and outputs the added image signals as another field signal.

According to another aspect of the invention, an imaging apparatus includes a plurality of pixel portions that are arranged in a matrix manner. Each pixel portion has a photoelectric conversion portion and an electric charge accumulating portion. Each electric charge accumulating portion is disposed above a semiconductor substrate and accumulates electric charges generated in the corresponding photoelectric conversion portion. A method of driving the imaging apparatus includes: outputting imaging signals corresponding to amounts of the electric charges accumulated in the electric charge accumulating portions; adding the imaging signals of two adjacent lines of pixel portions among the plurality of pixel portions; and in still-image shooting, performing a first operation and a second operation every exposure operation in which electric charges in the photoelectric conversion portions are discharged and then electric charges are accumulated in the photoelectric conversion portions, so as to output signals of one frame. The first operation reads out the imaging signals using a pattern containing combinations of two adjacent lines, adds the imaging signals of each combination of the two adjacent lines and outputs the added image signals as a field signal. The second operation reads out the imaging signals using a pattern containing combinations of two adjacent lines and being obtained by shifting the pattern for the first operation by one line, adds the imaging signals of each combination of the two adjacent lines and outputs the added image signals as another field signal.

With the above configuration and steps, an imaging apparatus and a method of driving an imaging apparatus that are suitable for both of the moving-image shooting and the still-image shooting can be provided.

### BRIEF DESCRIPTION OF THE DRAWINGS

FIGS. 1A and 1B are schematic plan views showing the configuration of an imaging device.

FIG. 2 is a schematic section view showing the configuration of a pixel portion shown in FIG. 1.

FIG. 3 is an equivalent circuit diagram of the pixel portion shown in FIG. 2.

FIG. 4 is a timing chart showing a signal reading-out timing in the pixel portion.

FIG. 5 is a diagram showing an example of color filters that are disposed above the pixel portions.

FIG. 6 is a timing chart showing a still-image shooting operation.

FIG. 7 is a timing chart showing a moving-image shooting operation.

FIG. 8 is a diagram showing the circuit configuration of a pixel portion of an imaging device according to a modified example.

FIG. 9 is a timing chart showing a signal reading timing in the pixel portion shown in FIG. 8.

### DETAILED DESCRIPTION OF EMBODIMENTS OF THE INVENTION

Hereinafter, embodiments of the invention will be described with reference to the accompanying drawings. An imaging device described below is used with being mounted in an imaging apparatus such as a digital camera or a digital video camera, or a cellular phone having an image shooting function.

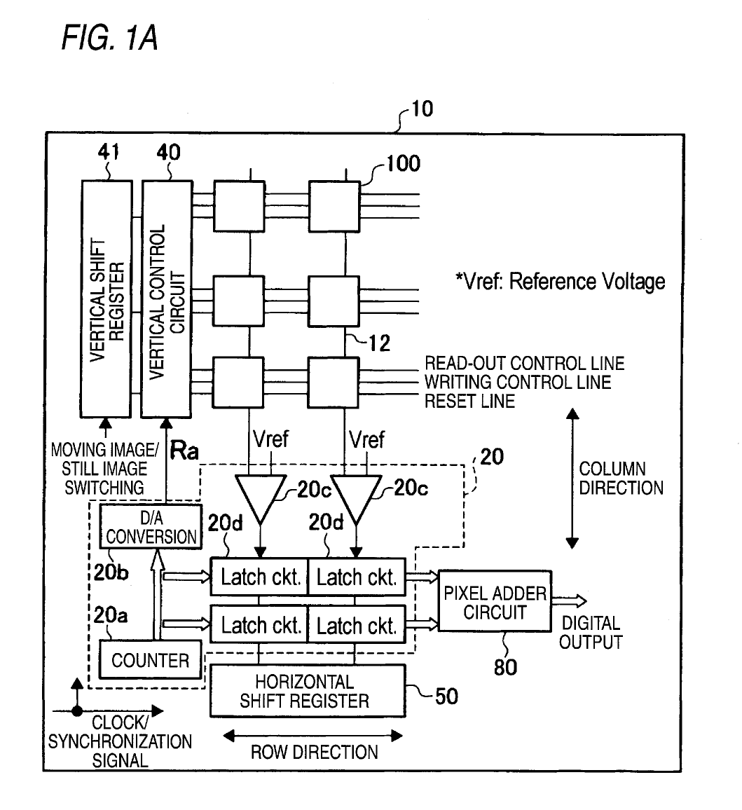

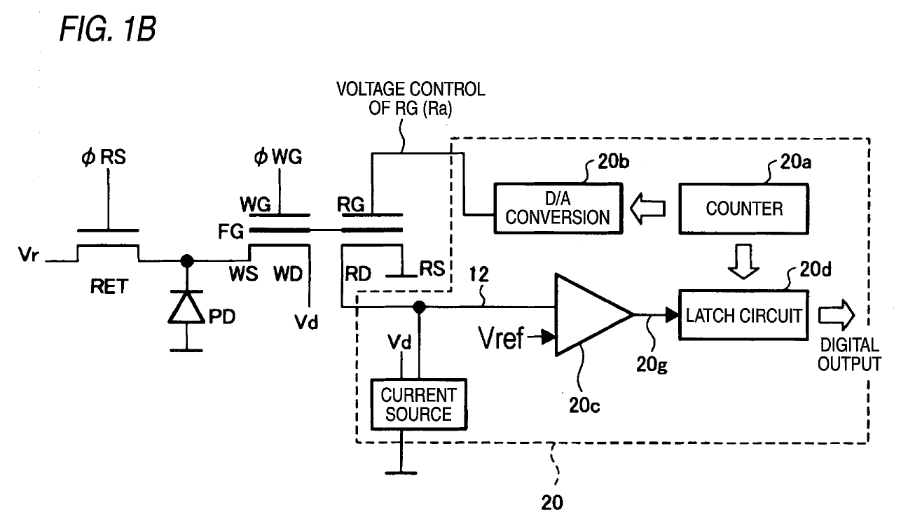

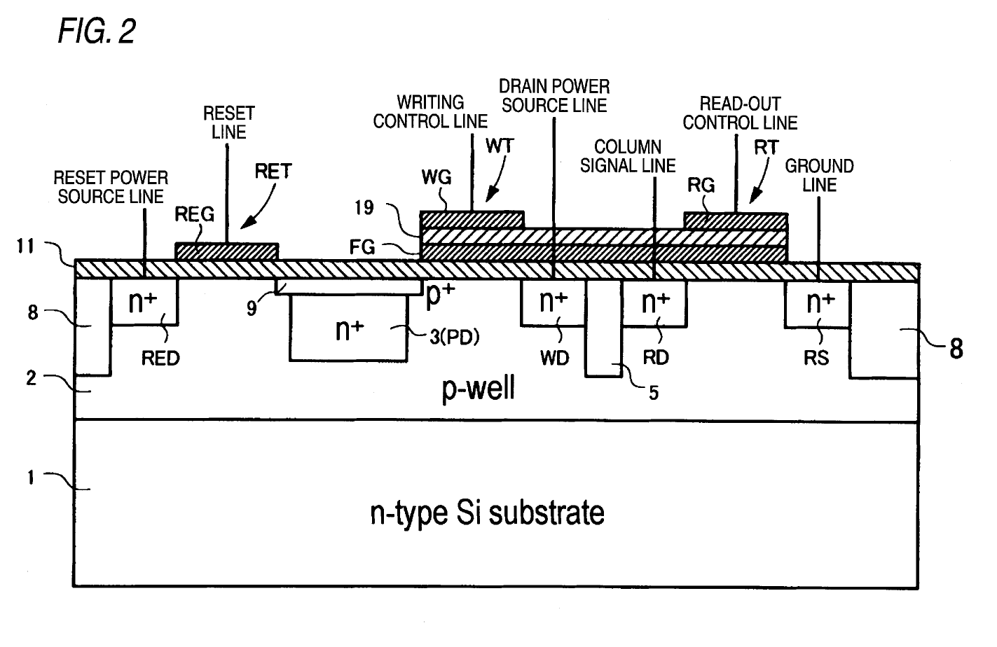

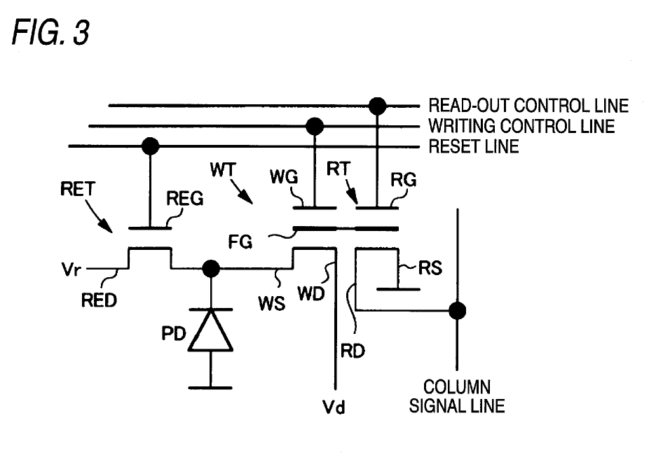

FIGS. 1A and 1B are schematic plan views showing the configuration of an imaging device. FIG. 2 is a schematic section view showing the configuration of a pixel portion shown in FIG. 1. FIG. 3 is an equivalent circuit diagram of the pixel portion shown in FIG. 2.

FIG. 1A is a schematic plan view showing the configuration of a solid-state imaging device 10. FIG. 1B is a diagram showing a signal read-out circuit of the solid-state imaging device 10.

The solid-state imaging device 10 includes a plurality of pixel portions 100 that are arranged at regular intervals in a matrix manner in a row direction and in a column direction, on a same plane.

The pixel portion 100, as shown in FIG. 2, includes an n-type silicon substrate 1 and an n-type impurity layer 3 which is formed in a semiconductor substrate having a p-well layer 2 formed on the n-type silicon substrate 1. The n-type impurity layer 3 is formed in the p-well layer 2, and pn junction between the n-type impurity layer 3 and the p-well layer 2 forms a photo diode PD serving as a photoelectric conversion portion. Hereinafter, the n-type impurity layer 3 is referred to as a photoelectric conversion portion 3. The photoelectric conversion portion 3 is formed as a so-called buried-type photo diode in which a high-density p-type impurity layer 9 is formed on its surface for being completely depleted and suppressing a dark current.

In the semiconductor substrate, a read-out portion that can read out to an outside a voltage signal (hereinafter, referred to as an imaging signal) in response to electric charges generated by the photoelectric conversion portion 3 is formed.

This read-out portion includes a writing transistor WT and a reading transistor RT. The writing transistor WT and the reading transistor RT are separated from each other by an element separating region 5 which is disposed on the right side of the photoelectric conversion portion 3 with being slightly spaced apart from the photoelectric conversion portion 3. Also, elements of pixel portions 100 in the p-well layer 2 are separated by element separating regions 8.

As an element separating method, a LOCOS (Local Oxidation of Silicon) method, an STI (Shallow Trench Isolation) method, a high-density impurity ion injecting method, or the like may be used.

The writing transistor WT has an MOS transistor structure including the photoelectric conversion portion 3 serving as a source region, a writing drain WD that is a drain region disposed on the right side of the photoelectric conversion portion 3 with being spaced apart from the photoelectric conversion portion 3 and formed of high-density n-type impurity, a writing control gate WG that is a gate electrode disposed above the semiconductor substrate through an oxide film 11 and between the photoelectric conversion portion 3 and the writing drain WD, and a floating gate FG that is disposed between the writing control gate WG and the oxide film 11.

Examples of a conductive material constituting the writing control gate WG include polysilicon. Also, doped polysilicon in which phosphorus (P), arsenic (As), and/or boron (B) are doped at high density may be used. Alternatively, as the conductive material, silicide or salicide (Self-aligned Silicide) that is formed by combining various metals such as titanium (Ti), tungsten (W) or the like and silicon may be used.

The reading transistor RT has an MOS transistor structure including a read-out drain RD that is a drain region disposed on the right side of the element separating region 5 and formed of high-density n-type impurity, a read-out source RS that is disposed on the right side of the read-out drain RD with being slightly spaced apart from the read-out drain RD and formed of n-type impurity, a read-out control gate RG that is a gate electrode disposed above the semiconductor substrate through the oxide film 11 and between the read-out drain RD and the read-out source RS, and the floating gate FG disposed between the read-out control gate RG and the oxide film 11.

As a conductive material of the read-out control gate RG, the same material as that of the writing control gate WG may be used. A column signal line 12 is connected to the read-out drain RD. A ground line is connected to the read-out source RS. The impurity density of the read-out drain RD is adjusted so as to form an ohmic contact with the row signal line 12. Also, the impurity density of the read-out source RS is adjusted so as to form an ohmic contact with the ground line.

The floating gate FG is an electrically floating electrode that is disposed above the semiconductor substrate via the oxide film 11 and between the p-type impurity layer 9 and the read-out source RS. Above the floating gate FG, the writing control gate WG and the read-out control gate RG are disposed through an insulating film 19 that is formed of silicon oxide or the like. As a conductive material that configures the floating gate FG, the same material as that of the writing control gate WG may be used.

The floating gate FG is not limited to have a single floating gate FG shared by the writing transistor WT and the reading transistor RT. Thus, floating gates FG may be separately provided for the writing transistor WT and the reading transistor RT, or two separated floating gates FG may be electrically connected to each other through a wiring. Also, the writing control gate WG and the photoelectric conversion portion 3 may partially overlap each other, so that injection of electric charges from the photoelectric conversion portion 3 to the floating gate FG can easily occur.

The floating gate FG serves as a electric charge accumulating portion that accumulates electric charges generated by the photoelectric conversion portion 3.

The semiconductor substrate is further provided with a reset transistor RET that resets the electric charges generated by the photoelectric conversion portion 3. This reset transistor RET has an MOS transistor structure including the photoelectric conversion portion 3 serving as a source area, a reset drain RED that is disposed on the left side of the photoelectric conversion portion 3 with being spaced apart from the photoelectric conversion portion 3 and is formed of high-density n-type impurity, and a reset gate REG that is disposed above a space between the photoelectric conversion portion 3 and the reset drain RED through the oxide film 11.

The pixel portion 100 is configured such that light is not incident to an area other than a part of the photoelectric conversion portion 3 by using a light shielding film (not shown in the figure).

The solid-state imaging device 10 includes a vertical control circuit 40, a vertical shift resistor 41, a read-out circuit 20, a horizontal shift register 50 and a pixel adder circuit 80. The vertical control circuit 40 controls the writing transistor WT, the reading transistor RT, and the reset transistor RET. The vertical shift register 41 sequentially selects a pixel row to be controlled. The read-out circuit 20 has a function of detecting a threshold voltage of the reading transistor RT of a selected pixel as an image signal and temporarily maintaining the detected image signals of pixels located in an n-th line and an (n+1)-th line in the column direction as digital signals. The horizontal shift register 50 performs sequential read-out control of the temporarily-maintained pixel signals for the two columns in the row direction in units of two pixels that are arranged in the column direction. The pixel adder circuit 80 sequentially adds the image signals of the two pixels arranged in the column direction.

The read-out circuit 20 and the pixel adder circuit 80 may not be built in the solid-state imaging device 10 but be provided in an imaging apparatus having the solid-state imaging device 10. In such a case, a part of the configuration and functions of the read-out circuit 20 and the pixel adder circuit 80 may be performed by another circuit or a calculation processing section.

The reset gates REG of the reset transistors RET are connected to the vertical control circuit 40 through reset lines. A reset voltage is applied to the reset drains RED through reset power source lines. At the start of an exposure period, a rest pulse is input to the reset gates REG from the vertical control circuit 40 through the reset lines. When the reset transistors RET are turned on, unnecessary electric charges accumulated in the photoelectric conversion portions 3 are discharged to the reset drains RED (an example of a first electric-charge discharging unit).

The read-out circuit 20 is provided so as to correspond to the respective columns each including the plural pixel portions 100 which are arranged in the column direction. The read-out circuit 20 is connected to the read-out drains RD of the pixel portions 100 of the respective column though the column signal lines 12.

The read-out circuit 20, as shown in FIG. 1B, is configured to include a counter 20a, a D/A converter 20b, a plurality of comparators 20c, and a plurality of latch circuits 20d. The comparators 20c are connected to the respective column signal lines 12. The number of the comparators 20c is equal to the number of pixels which are arranged in the row direction. The number of the latch circuits 20d is twice as many as the number of the comparators 20c. The latch circuits 20d latch (maintain) image signals of pixels located in the n-th line and the (n+1)-th line in the column direction.

The counter 20a is connected to the D/A converter 20b and the latch circuit 20d. As the counter 20a counts up, a ramp waveform signal Ra whose voltage gradually increases is output as an analog signal from the D/A converter 20b, and a corresponding digital signal is input to the latch circuits 20d.

The output terminal of the D/A converter 20b is connected to the read-out control gates RG of the pixels 100 of the n-th line selected by the vertical control circuit 40 through the vertical control circuit 40.

The reading-out of image signals is started when the counter 20a counts up. When the counter 20a counts up, for example, from zero, the voltage of the D/A converter 20b gradually increases, and the voltages of the read-out control gates RG of the pixels 100 selected by the vertical control circuit 40 also gradually increase.

When the voltage of the read-out control gate RG increases and exceeds a threshold voltage of the reading transistor RT, the reading transistor RT becomes conductive. Thus, when a current flows though the column signal line 12, the comparator 20c connected to the column signal line 12 detects the current and outputs a latch signal 20g. The latch circuit 20d latches (maintains) a count value (digital signal) of the counter 20a at a point in time when the latch signal is received. In this manner, changes (image signals) in the threshold voltages of the reading transistors RT can be latched (maintained) in the read-out latch circuits 20d as digital values. Subsequently, the vertical control circuit 40 selects the pixels 100 located in the (n+1)-th line, and by performing a series of operations that is the same as those for the n-th line, changes (image signals) in the threshold voltages of the reading transistors RT can be latched (maintained) in the read-out latch circuits 20d as digital values.

When one latch circuit 20d is selected by the horizontal shift register 50, the count value (digital signal) of the counter 20a, which is maintained in the selected latch circuit 20d, is output as a digital signal.

The method of reading out changes in the threshold voltages of the reading transistors RT by using the read-out circuit 20 is not limited to the above-described method. For example, drain currents of the reading transistors RT at a time when a predetermined voltage is applied to the read-out control gates RG and the read-out drains RD may be read out as imaging signals.

The vertical control circuit 40 is connected to the writing control gate WG, the read-out control gate RG, and writing drain WD of each pixel portion 100 of each line configured by the plural pixel portions 100, which are arranged in the row direction, through a writing control line, a read-out control line, and a writing power source line. The impurity density of the writing drain WD is adjusted so as to form an ohmic contact with the writing power source line.

The vertical control circuit 40 controls the writing transistors WT to perform an operation for injecting electric charges generated by the photoelectric conversion portions 3 into the floating gates FG for accumulation. As a method of injecting electric charges into the floating gates FG, there are two methods, that is, (i) a CHE injecting method in which electric charges are injected into the floating gates FG by using channel hot electrons (CHE) and (ii) a tunnel electron injecting method in which electric charges are injected into the floating gates FG by using a Fowler-Nordheim (F-N) tunnel current.

Also, the vertical control circuit 40 controls the reading transistors RT by using the above-described method, to perform an operation for reading out imaging signals in response to the electric charges accumulated in the floating gates FG

Then, the vertical control circuit 40 performs an operation for discharging the electric charges accumulated in the floating gates FG for erasing. Particularly, the vertical control circuit 40 erases the electric charges inside the floating gates FG by applying a voltage having a polarity (for example, a negative polarity) opposite to a first polarity to the writing control gates WG and the read-out control gates RG to thereby discharge the electric charges accumulated in the floating gates FG to the writing control gates WG and the read-out control gates RG (an example of a second electric-charge discharging unit).

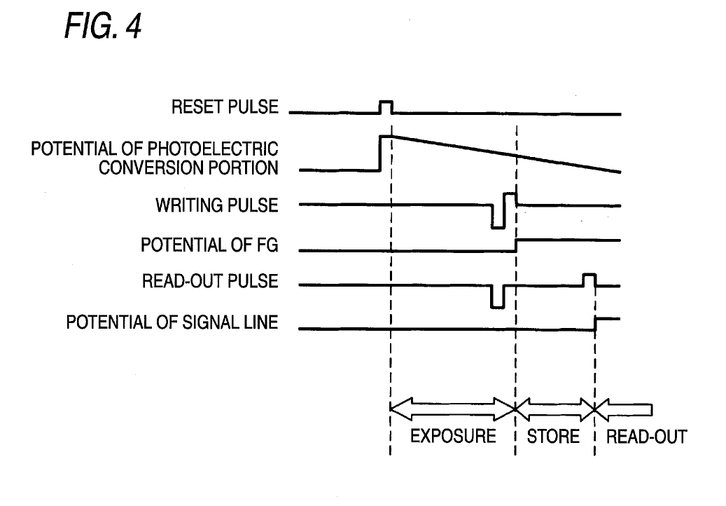

Next, a signal reading-out timing for each pixel portion will be described. FIG. 4 is a timing chart showing the signal reading-out timing of the pixel portion.

When a reset pulse is applied, unnecessary electric charges accumulated in the photoelectric conversion portion 3 are discharged, and then exposure (generation and accumulation of signal electric charges) is started. When the exposure period ends, a writing pulse is applied, and the signal electric charges accumulated in the photoelectric conversion portion 3 are stored in the floating gate FG. At this time, before the signal charges are stored in the floating gate FG, the floating gate FG is reset by setting the writing pulse and the read-out pulse to have negative values simultaneously. Next, when a read-out pulse is applied, the signal electric charges stored in the floating gate FG are read out to the signal line 12 in a non-destructive manner. Here, a time interval from the applying of the reset pulse to the applying of the writing pulse is the exposure period. By controlling the time interval from the applying of the reset pulse to the applying of the writing pulse, the exposure period can be adjusted (electronic shutter function). Also, there arises no problem even if the exposure period and the read-out time overlap with each other.

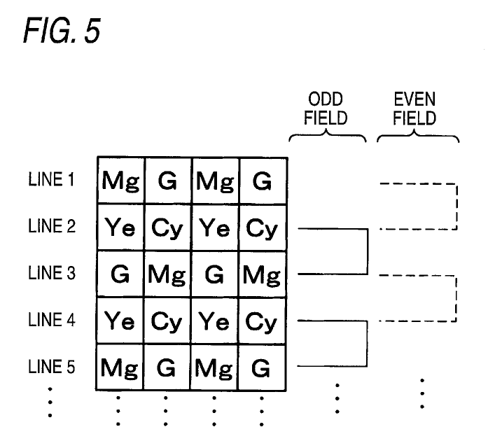

FIG. 5 is a diagram showing an example of color filters that are provided above the pixel portions. These color filters are configured by filters of four colors of magenta (Mg), green (G), yellow (Ye), and cyan (Cy). One filter is provided for one pixel portion.

When attention is given to four arbitrary pixels consisting of two pixels arranged in an row direction by two pixels arranged in the column direction out of the entire pixel portions, the filters of Mg, G, Ye, and Cy, that is, one filter of each color are included in any case. The imaging device performs signal reading-out by using the line sequential color difference method (which will be described below) and the color filters having the above-described arrangement.

In this example, imaging signals of the pixel portions located in a line 2 an imaging signals of the pixel portions located in a line 3 are added (mixed) together, imaging signals of a line 4 and imaging signals of a line 5 are added (mixed) together, and for a line 6 and subsequent lines, similarly, imaging signals of adjacent lines are added (mixed) together. Then, the added imaging signals are output as an odd-field signal. Next, imaging signals of the pixel portions located in a line 1 and the imaging signals of the pixel portions located in the line 2 are added (mixed) together, the imaging signals of the line 3 and the imaging signals of the line 4 are added (mixed) together, and for the line 5 and subsequent lines, similarly, imaging signals of adjacent lines are added (mixed) together. Then, the added imaging signals are output as an even-field signal. In this example, one frame for the all pixel portions is read out twice as the odd-field signal and the even-field signal.

In this example, the imaging signals of the plural pixel portions are read out two adjacent lines by two adjacent lines, and the imaging signals of each combination of adjacent two lines are added (mixed) together and output as a field signal.

In the line sequential color difference method in which filters of complementary colors are used, imaging signals corresponding to two pixel portions are added (mixed) together. Therefore, sensitivity that is three to four times higher than that in the case where filters of primary colors of R (red), G (green), and B (blue) are used can be acquired.

The arrangement of the color filters is not limited to the line sequential color difference filter arrangement. Thus, a different arrangement of the color filters may be used so long as imaging signals of plural pixel portions can be added (mixed). For example, the color filters may be arranged in a stripe filter arrangement or a field-interleave arrangement.

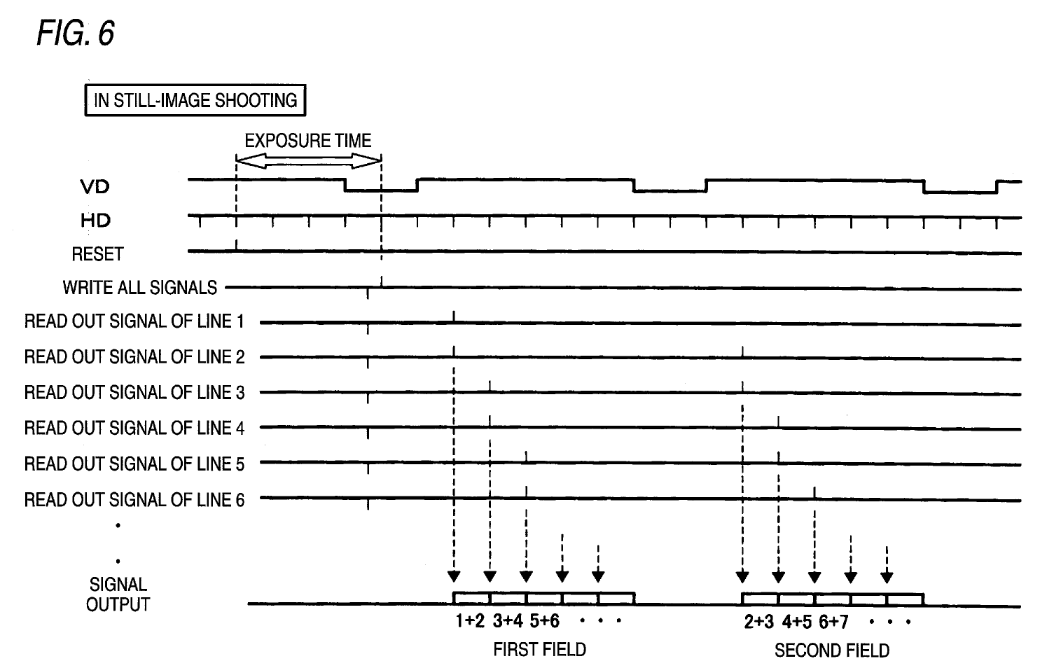

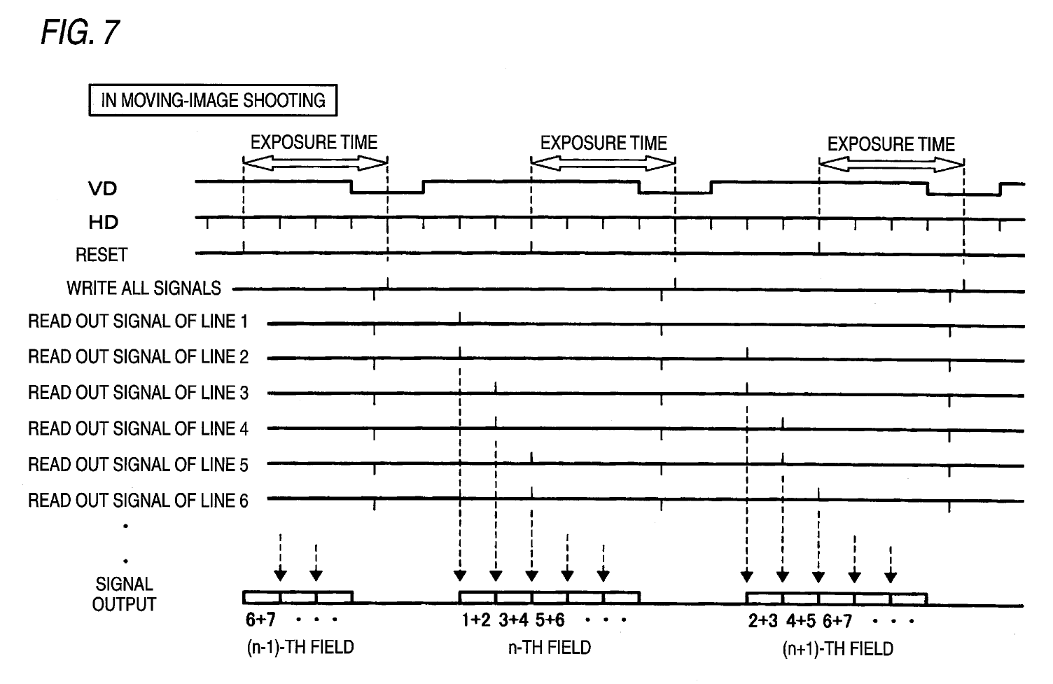

Next, an operation for shooting a still image and an operation for shooting a moving image by using the imaging apparatus including the imaging device will be described. FIG. 6 is a timing chart showing the still-image shooting operation. FIG. 7 is a timing chart showing the moving-image shooting operation. In the following description, the imaging apparatus having the imaging device shown in FIG. 1 will be used as an example. It is assumed that the color filters of the imaging device are arranged as shown in FIG. 5. In FIGS. 6 and 7, “VD” denotes a vertical synchronization signal, “HD” denotes a horizontal synchronization signal, and “RESET” denotes the reset pulse.

As shown in FIG. 6, when the still-image shooting operation is started, unnecessary electric charges accumulated in the photoelectric conversion portions are discharged by applying the reset pulse. The exposure period starts from a point in time when the reset pulse is applied. As the exposure period starts, signal charges are generated by the photoelectric conversion portions, and the generated signal electric charges are accumulated.

When a writing pulse is applied to each pixel portion, the signal charges accumulated during the exposure period by each photoelectric conversion portion are transferred to the electric charge accumulating portion of each pixel portion, and the exposure period ends (electronic shutter). The electric charge accumulating portion is in a reset state where the electric charges are discharged by the electric charge discharging unit before the signal charges are transferred.

Next, the imaging signals are sequentially read out from the electric charge accumulating portions of the respective pixel portions. Here, the imaging signals of the pixel portions of the lines 1 and 2 are read out, the imaging signals of two pixel portions of a same column are added (mixed) together by the read-out circuit 20, the horizontal shift register 50, and the pixel adder circuit 80, and the added image signal is output. Thereafter, imaging signals of the pixel portions of lines 3 and 4 are read out, the imaging signals of two pixel portions of a same column are added (mixed) together by the read-out circuit 20, the horizontal shift register 50, and the pixel adder circuit 80, and the added image signal is output. Although not shown in the figure, for line 5 and subsequent lines, similarly, imaging signals of an odd line and an even line adjacent to the odd line are added (mixed) together, and the added signals are sequentially output to the horizontal register. As described above, a group of the added imaging signals is output as one field signal (here, referred to as a “first field signal”). The electric charges accumulated in the electric charge accumulating portions are maintained state, that is, are in a non-destructive state even after the first field signal is output.

After the first field signal is output, imaging signals of a next field signal (hereinafter, referred to as a “second field signal”) are read out. Here, the imaging signals of the pixel portions of lines 2 and 3 are read out, the imaging signals of two pixel portions of a same column are added (mixed) together by the read-out circuit 20, the horizontal shift register 50, and the pixel adder circuit 80, and the added image signal is output. Thereafter, the imaging signals of the pixel portions of lines 4 and 5 are read out, the imaging signals of two pixel portions of a same column are added (mixed) together by the read-out circuit 20, the horizontal shift register 50, and the pixel adder circuit 80, and the added image signal is output. Similarly, the imaging signals of the pixel portions of lines 6 and 7 (not shown) are added (mixed) and output. For line 8 and subsequent lines not shown in the figure, similarly, the imaging signals of an odd line and an even line adjacent to the odd line are added (mixed) together, and the added image signals are sequentially output to the horizontal register. As described above, one group of the added imaging signals is output as the second field signal.

With reference to the color filter arrangement shown in FIG. 5, in the first field signal, the added signals of the lines 1 and 2 can be represented as (Mg+Ye), (G+Cy), (Mg+Ye), (G+Cy), . . . , and the added signals of the lines 3 and 4 can be represented as (G+Ye), (Mg+Cy), (G+Ye), (Mg+Cy), . . . . Also, similarly to the added signals of the lines 1 and 2, the added signals of the lines 5 and 6 can be represented as (Mg+Ye), (G+Cy), (Mg+Ye), (G+Cy), . . . . The added signals of the subsequent lines can be represented similarly.

In the second field signal, the added signals of the lines 2 and 3 can be represented as (Ye+G), (Cy+Mg), (Ye+G), (Cy+Mg), . . . , and the added signals of the lines 4 and 5 can be represented as (Ye+Mg), (Cy+G), (Ye+Mg), (Cy+G), . . . . Also, similarly to the added signals of the lines 2 and 3, the added signals of the lines 6 and 7 can be represented as (Ye+G), (Cy+Mg), (Ye+G), (Cy+Mg), . . . . The added signals of the subsequent lines can be represented similarly.

By adding the added signals of two pixel portions adjacent to each other in the horizontal direction out of the added signals of two lines, a luminance signal Y=2R+3G+2B can be acquired. Also, by performing a subtraction process for two pixel signals of pixel portions arranged in the horizontal direction, color difference signals Cr=2R−G and Cb=2B G can be acquired for each line. Also, details of this signal processing method, for example, is described as a color process for the line sequential color difference method in “Design Technology of Television Cameras” (Video Information Media Society, published by Corona Publishing Co., Ltd).

In other words, in the still-image shooting, a controller of the imaging device can perform (i) a first operation in which imaging signals of the plural pixel portions are read out using a pattern containing combinations of two adjacent lines, and the imaging signals of each combination of the adjacent two lines are added (mixed) together and output as a first field signal and (ii) a second operation in which imaging signals are read out using a pattern containing combinations of two adjacent lines and being obtained by shifting the pattern for the first operation by one line, and the imaging signals of each combination of the adjacent two lines are added (mixed) together and output as a second field signal. In the still-image shooting, the controller performs the first operation and the second operation so as to output signals of one frame, for one exposure in which the electric charges are accumulated in the electric charge accumulating portions after the electric charges of the photoelectric conversion portions are discharged. Accordingly, signals of one frame can be generated by reading out the imaging signal of a same pixel portion twice in accordance with the two patterns and outputting the two field signals. As a result, a still image having high sensitivity can be acquired.

In moving-image shooting, as shown in FIG. 7, an exposure operation and a field signal reading-out operation are repeatedly performed by outputting one field signal for each exposure. For example, the field signals are read out 60 times, and a moving image is reproduced at 30 fps (frames per second).

It is assumed that each field signal is configured such that an n-th field signal is a combination of an added signal of lines 1 and 2, an added signal of lines 3 and 4 and the like. In this case, an (n+1)-th field signal output next is a combination of an added signal of lines 2 and 3, an added signal of lines 4 and 5 and the like.

In other words, in the moving-image shooting, the solid-state imaging device 10 outputs signals of one frame by performing the first operation or the second operation once for each exposure in accordance with the control of the vertical control circuit 40 and alternately performing the first operation and the second operation every exposure. Accordingly, in the moving-image shooting process, only one field signal is output by performing the first operation or the second operation. Therefore, the process can be performed at a high speed.

The solid-state imaging device 10 can perform a shuttering operation at optimized timings in the still-image shooting and the moving-image shooting without using a mechanical shutter by having the controller to change the timing of the operation for accumulating the electric charges generated by the photoelectric conversion portions of the pixel portion in the electric charge accumulating portions.

Also, the solid-state imaging device 10 outputs the field signals by adding the imaging signals of the pixel portions of lines in both of the still-image shooting and the moving-image shooting. Accordingly, signal format output from the imaging device is the same all the time. Thus, the signal processing need not be changed in the moving-image shooting and the still-image shooting. Thereby, the signal processing can be performed using a same signal processing circuit.

Also, compared with the case where a method in which the exposure period and the signal reading-out timing of the respective lines in one frame are set to be different from each other is used as in a related-art progressive CMOS (Progressive Scan CMOS), the signal reading-out speed can be set to be a half. Accordingly, the signal reading-out operation can be performed with low power consumption, and occurrence of noise accompanied by the signal reading-out operation can be decreased.

Next, modified examples of the solid-state imaging device will be described.

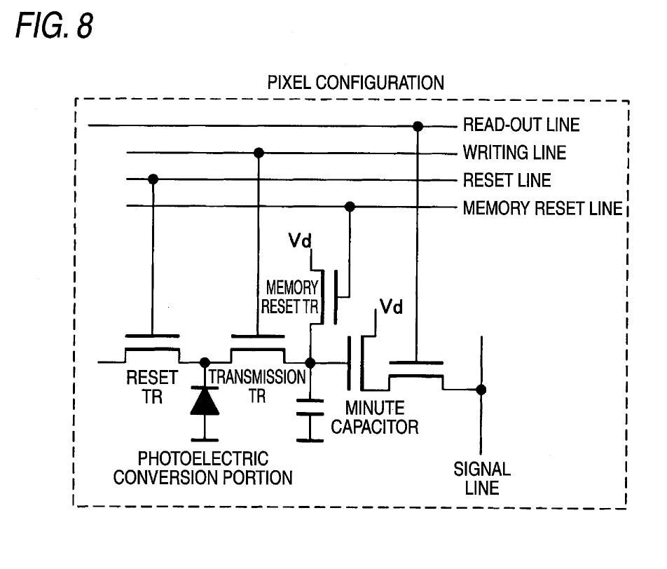

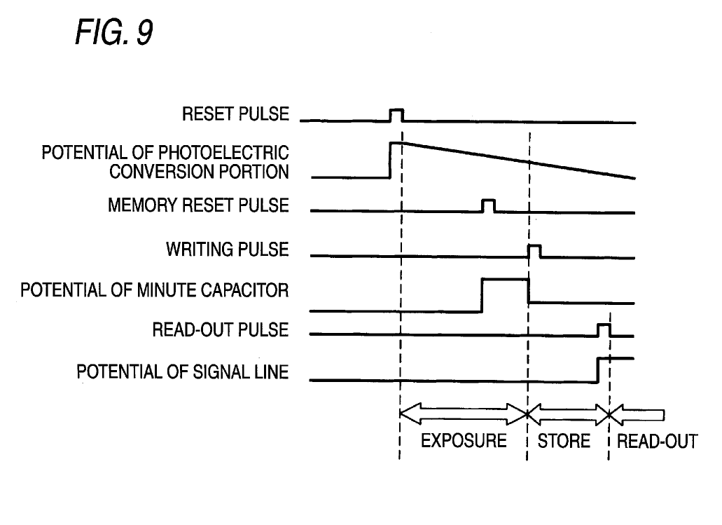

FIG. 8 is a diagram showing the circuit configuration of a pixel portion of a solid-state imaging device according to a modified example. FIG. 9 is a timing chart showing a signal reading timing of the pixel portion shown in FIG. 8.

Each pixel portion of this configuration, is similar the configuration of the pixel portion shown in FIG. 4 in that each pixel portion includes a photoelectric conversion portion such as a photo diode and an electric charge discharging unit that resets the electric charges, which are accumulated in the photoelectric conversion portion and are unnecessary. On the other hand, the pixel portion shown in FIG. 8 is different from the pixel portion shown in FIG. 4 in that each pixel portion includes (i) a capacitor that is configured by a condenser or the like and temporarily maintains the electric charges of the photoelectric conversion portion, which are read out in accordance with the control of the writing pulse, and (ii) an MOS transistor that reads out the electric charges accumulated in the capacitor in accordance with the control of a read-out pulse. The capacitor serves as a memory portion having minute capacity. Also, the pixel portion may be configured to read out electric charges from the capacitor in a non-destructive manner in accordance with the control of the read-out pulse. Here, resetting of the electric charges accumulated in the capacitor is performed by a memory reset transistor TR that is separately provided. Here, the memory reset transistor TR serves as a second electric-charge discharging unit. When the electric charges accumulated in the capacitor are reset, a memory reset line is connected to the memory reset transistor TR, and the memory reset transistor TR is turned on in accordance with the control of a reset pulse, which is input through the memory reset line.

As shown in FIG. 9, when the reset pulse is applied, unnecessary electric charges accumulated in the photoelectric conversion portion are discharged, and thereafter, an exposure operation (generation and accumulation of signal electric charges) is started. During the exposure period, a reset pulse is applied to the memory reset transistor, and the capacitor is reset. When the exposure period ends, a writing pulse is applied, and the electric charges in the photoelectric conversion portion are accumulated in the capacitor. Next, when a read-out pulse is applied, the electric charges stored in the capacitor are read out into the signal line in a non-destructive manner. Here, a time interval from the applying of the reset pulse to the applying of the writing pulse is the exposure period. The controller can adjust the exposure period by controlling the electronic shutter function. Here, the exposure period and the read-out time may overlap each other.

Also, in the solid-state imaging device provided with the pixel portion having the above-described configuration, the shutter operation can be performed at an optimized timing in both of the still-image shooting and the moving-image shooting. Also, in the solid-state imaging device, the signal process does not need to be changed in the moving-image shooting and the still-image shooting. Accordingly, the processes can be performed by the same signal processing circuit.

This specification has described, at least, the followings:

(1) An imaging apparatus includes a plurality of pixel portions that are arranged in a matrix manner, a read-out circuit, a pixel adder and a controller. Each pixel portion includes a photoelectric conversion portion and an electric charge accumulating portion. Each electric charge accumulating portion is disposed above a semiconductor substrate and accumulates electric charges generated in the corresponding photoelectric conversion portion. The read-out circuit reads out imaging signals corresponding to amounts of the electric charges accumulated in the electric charge accumulating portions. The pixel adder adds the imaging signals of two adjacent lines of pixel portions among the plurality of pixel portions. In still-image shooting, the controller performs a first operation and a second operation every exposure operation in which electric charges in the photoelectric conversion portions are discharged and then electric charges are accumulated in the photoelectric conversion portions, so as to output signals of one frame. The first operation reads out the imaging signals using patterns each containing a combination of two adjacent lines, adds the imaging signals of each combination of the two adjacent lines and outputs the added image signals as a field signal. The second operation reads out the imaging signals using patterns each containing a combination of two adjacent lines and being obtained by shifting the patterns for the first operation by one line, adds the imaging signals of each combination of the two adjacent lines and outputs the added image signals as another field signal.

(2) In the imaging apparatus of (1), in moving-image shooting, the controller may perform the first operation or the second operation once for the one exposure operation and alternately perform the first operation and the second operation every exposure operation so as to output signals of one frame.

(3) In the imaging apparatus of any one of (1) to (2), each electric charge accumulating portion may include a light-shielded floating gate.

(4) The imaging apparatus of any one of (1) to (3) may further include capacitors and MOS transistors. Each capacitor accumulates the electric charges generated in the corresponding photoelectric conversion portion. Each MOS transistor reads out the electric charges accumulated in the corresponding capacitor in accordance with control of a read-out pulse.

(5) The imaging apparatus of any one of (1) to (4) may further include a first electric-charge discharging unit, a second electric-charge discharging unit and a writing unit. The first electric-charge discharging unit simultaneously discharges the electric charges of the photoelectric conversion portions of all the pixel portions at start of an exposure period. The second electric-charge discharging unit simultaneously discharges the electric charges accumulated in the photoelectric conversion portions of all the pixel portions. The writing unit simultaneously accumulates the electric charges of the photoelectric conversion portions in the electric charge accumulating portions of all the pixel portions.

(6) The imaging apparatus of any one of (1) to (5) may further include complementary color filters that correspond to a line sequential color difference method and are arranged above the pixel portions.

(7) The imaging apparatus of any one of (1) to (6) may further include filters that are disposed above the pixel portions. The filters may be arranged in a stripe filter arrangement or a field-interleave arrangement.

(8) An imaging apparatus includes a plurality of pixel portions that are arranged in a matrix manner. Each pixel portion has a photoelectric conversion portion and an electric charge accumulating portion. Each electric charge accumulating portion is disposed above a semiconductor substrate and accumulates electric charges generated in the corresponding photoelectric conversion portion. A method of driving the imaging apparatus includes: outputting imaging signals corresponding to amounts of the electric charges accumulated in the electric charge accumulating portions; adding the imaging signals of two adjacent lines of pixel portions among the plurality of pixel portions; and in still-image shooting, performing a first operation and a second operation every exposure operation in which electric charges in the photoelectric conversion portions are discharged and then electric charges are accumulated in the photoelectric conversion portions, so as to output signals of one frame. The first operation reads out the imaging signals using patterns each containing a combination of two adjacent lines, adds the imaging signals of each combination of the two adjacent lines and outputs the added image signals as a field signal. The second operation reads out the imaging signals using patterns each containing a combination of two adjacent lines and being obtained by shifting the patterns for the first operation by one line, adds the imaging signals of each combination of the two adjacent lines and outputs the added image signals as another field signal.

(9) The method of (8) may further include, in moving-image shooting, performing the first operation or the second operation once for the one exposure operation and alternately performing the first operation and the second operation every exposure operation so as to output signals of one frame.

(10) In the method of any one of (8) to (9), each electric charge accumulating portion may include a light-shielded floating gate.

(11) The method of any one of (8) to (10) may further include: accumulating the electric charges generated in each photoelectric conversion portion in a corresponding capacitor; and reading out the accumulated electric charges in accordance with control of a read-out pulse.

(12) The method of any one of (8) to (11) may further include: simultaneously discharging the electric charges of the photoelectric conversion portions of all the pixel portions at start of an exposure period; simultaneously discharging the electric charges accumulated in the photoelectric conversion portions of all the pixel portions; and simultaneously accumulating the electric charges of the photoelectric conversion portions in the electric charge accumulating portions of all the pixel portions.

(13) In the method of any one of (8) to (12), complementary color filters corresponding to a line sequential color difference method may be arranged above the pixel portions.

(14) In the method of any one of (8) to (13), filters may be disposed above the pixel portion. The filters may be arranged in a stripe filter arrangement or a field-interleave arrangement.

What is claimed is:

1. An imaging apparatus comprising:
a plurality of pixel portions that are arranged in a matrix manner, each pixel portion including
a photoelectric conversion portion, and
an electric charge accumulating portion that is disposed above a semiconductor substrate and accumulates electric charges generated in the corresponding photoelectric conversion portion;
a read-out circuit that reads out imaging signals corresponding to amounts of the electric charges accumulated in the electric charge accumulating portions;
a pixel adder that adds the imaging signals of two adjacent lines of pixel portions among the plurality of pixel portions; and
a controller that, in still-image shooting, performs a first operation and a second operation every exposure operation in which electric charges in the photoelectric conversion portions are discharged and then electric charges are accumulated in the photoelectric conversion portions, so as to output signals of one frame, wherein
the first operation reads out the imaging signals using a pattern containing combinations of two adjacent lines, adds the imaging signals of each combination of the two adjacent lines and outputs the added image signals as a field signal, and
the second operation reads out the imaging signals using a pattern containing combinations of two adjacent lines and being obtained by shifting the pattern for the first operation by one line, adds the imaging signals of each combination of the two adjacent lines and outputs the added image signals as another field signal.

2. The imaging apparatus according to claim 1, wherein
in moving-image shooting, the controller performs the first operation or the second operation once for the one exposure operation and alternately performs the first operation and the second operation every exposure operation so as to output signals of one frame.

3. The imaging apparatus according to claim 1, wherein each electric charge accumulating portion includes a light-shielded floating gate.

4. The imaging apparatus according to claim 1, further comprising:
capacitors each of which accumulates the electric charges generated in the corresponding photoelectric conversion portion; and
MOS transistors each of which reads out the electric charges accumulated in the corresponding capacitor in accordance with control of a read-out pulse.

5. The imaging apparatus according to claim 1, further comprising:
a first electric-charge discharging unit that simultaneously discharges the electric charges of the photoelectric conversion portions of all the pixel portions at start of an exposure period;
a second electric-charge discharging unit that simultaneously discharges the electric charges accumulated in the photoelectric conversion portions of all the pixel portions; and
a writing unit that simultaneously accumulates the electric charges of the photoelectric conversion portions in the electric charge accumulating portions of all the pixel portions.

6. The imaging apparatus according to claim 1, further comprising:
complementary color filters that correspond to a line sequential color difference method and are arranged above the pixel portions.

7. The imaging apparatus according to claim 1, further comprising:
filters that are disposed above the pixel portions, wherein
the filters are arranged in a stripe filter arrangement or a field-interleave arrangement.

8. A method of driving an imaging apparatus, wherein
the imaging apparatus includes a plurality of pixel portions that are arranged in a matrix manner, and
each pixel portion having
a photoelectric conversion portion, and
an electric charge accumulating portion that is disposed above a semiconductor substrate and accumulates electric charges generated in the corresponding photoelectric conversion portion, the method comprising:
outputting imaging signals corresponding to amounts of the electric charges accumulated in the electric charge accumulating portions;
adding the imaging signals of two adjacent lines of pixel portions among the plurality of pixel portions; and
in still-image shooting, performing a first operation and a second operation every exposure operation in which electric charges in the photoelectric conversion portions are discharged and then electric charges are accumulated in the photoelectric conversion portions, so as to output signals of one frame, wherein
the first operation reads out the imaging signals using a pattern containing combinations of two adjacent lines, adds the imaging signals of each combination of the two adjacent lines and outputs the added image signals as a field signal, and
the second operation reads out the imaging signals using a pattern containing combinations of two adjacent lines and being obtained by shifting the pattern for the first operation by one line, adds the imaging signals of each combination of the two adjacent lines and outputs the added image signals as another field signal.

9. The method according to claim 8, further comprising:
in moving-image shooting, performing the first operation or the second operation once for the one exposure operation and alternately performing the first operation and the second operation every exposure operation so as to output signals of one frame.

10. The method according to claim 8, wherein each electric charge accumulating portion includes a light-shielded floating gate.

11. The method according to claim 8, further comprising:
accumulating the electric charges generated in each photoelectric conversion portion in a corresponding capacitor; and
reading out the accumulated electric charges in accordance with control of a read-out pulse.

12. The method according to claim 8, further comprising:
simultaneously discharging the electric charges of the photoelectric conversion portions of all the pixel portions at start of an exposure period;
simultaneously discharging the electric charges accumulated in the photoelectric conversion portions of all the pixel portions; and
simultaneously accumulating the electric charges of the photoelectric conversion portions in the electric charge accumulating portions of all the pixel portions.

13. The method according to claim 8, wherein complementary color filters corresponding to a line sequential color difference method are arranged above the pixel portions.

14. The method according to claim 8, wherein
filters are disposed above the pixel portion, and
the filters are arranged in a stripe filter arrangement or a field-interleave arrangement.
